(19) United States
(12) Patent Application Publication
(10) Pub. No.: US 2003/0011529 A1
(43) Pub. Date: Jan. 16, 2003

(54) Antenna, in particular mobile radio antenna

(76) Inventor: Maximilian Göttl, (US)

Correspondence Address: Nixon & Vanderhye, 1100 North Glebe Road 8th Floor, Arlington, VA, 22201-4714, US

(21) Appl. No.: 10/204,214

(22) PCT Filed: Dec. 13, 2001
(86) PCT No.: PCT/EP01/14711

(30) Foreign Application Priority Data
Dec. 21, 2000 (DE) 100 64 129.6

(51) Int. Cl. H01Q 9/28

(52) U.S. Cl. 343/795; 343/793

(57) ABSTRACT

An improved antenna, in particular a mobile radio antenna, is distinguished by the following features:

at least one additional dielectric body (21) is provided, and

the at least one dielectric body (21) is arranged such that it is entirely arranged underneath the radiating elements (4a, 13) or more than 40% of its volume and/or of its weight, and in particular more than 50% or 60% of its volume and/or of its weight, are/is arranged underneath the radiating elements (4a, 13), for the lower frequency band on the one hand and/or on the other hand, such that it is arranged entirely, or at least 40%, 50% or 60% of its volume and/or of its weight are/is arranged, viewed from the reflector (11), above the radiating elements (4b, 15) which are provided for an upper frequency band.

The invention relates to an antenna, in particular a mobile radio antenna, as claimed in the precharacterizing clause of claim 1.

Mobile radio antennas for mobile radio base stations are normally constructed such that a number of radiating element arrangements are provided, located one above the other in the vertical direction, in front of a reflector plane. These radiating element arrangements may thus comprise a large number of dipole radiating elements, for example in the form of crucible dipoles, in the form of a dipole square etc., that is to say in the form of radiating element types which have a dipole structure. Antennas in the form of so-called patch radiating elements are likewise known.

As is known, various mobile radio frequency bands are provided, for example the 900 MHz frequency band for the so-called GSM 900 network, the 1800 MHz or, for example, the 1900 MHz frequency band, as well, for the so-called GSM 1800 network, as is normally used in the USA and in a large number of other countries. A frequency band around 2000 MHz has been provided for the next mobile radio generation, namely the UMTS network.

It is thus normal to design such mobile radio antennas as at least dual-band antennas, although triple band antennas may also be used (for example for the 900 MHz, for the 1800 and 1900 MHz or, for example, for the 2000 MHz band).

Furthermore, the antennas are preferably designed as dual-polarized antennas for operation with polarizations of +45° and −45°. It is also normal for antennas such as these to be protected against weather influences by a plastic shroud. This so-called radome has to achieve objects which are primarily mechanical and surrounds all the radiating antenna parts to the same extent. An antenna such as this for operation in at least two frequency bands that are offset with respect to one another has been disclosed, by way of example, in DE 198 23 749 A1.

However, one problem that frequently arises with two-band antennas or with multiband antennas in general such as these is that the 3 dB beam widths of the polar diagram in the azimuth direction differ widely for the different frequency ranges, that is to say for the different frequency bands. A further problem that occurs with two-band antennas, or with multiband antennas in general, is that cross-polar components can occur, which lead to a deterioration in the polar diagram characteristic. Finally, however, the VSWR ratio and/or the decoupling may also be disadvantageously influenced.

In principle, a large number of antennas are known from the prior art which are designed, however, for only a single frequency band, that is to say they can receive and transmit in only one frequency band. These may be linear-polarized or else dual-polarized antennas for transmission in only this said one frequency band. Antennas such as these which operate in only one frequency band are disclosed, for example, in the publications DE 199 01 179 A1, DE 198 21 223 A1, DE 196 27 015 C2, DE US 6,069,590, A and U.S. Pat. No. 6,069,586 A. All these prior publications deal with different types of problems, however, in general with the question of decoupling two polarizations in the same frequency band. Electrically conductive parts are generally used for this purpose, in order to produce decoupling elements that radiate parasitically.

In contrast, and against the background of the antenna disclosed in DE 198 23 749 A1, which forms this generic type, the object of the present invention is to provide a considerable improvement (irrespective of whether the antenna is operated with only one polarization or with a number of polarizations), at least for operation in two frequency bands, with regard to the 3 dB beam width and/or with regard to the suppression of the cross-polar component and/or of the VSWR ratio and/or with regard to decoupling and increasing the bandwidth.

According to the invention, the object is achieved on the basis of the features specified in claims 1, 2, 3 and/or 4. Advantageous refinements of the invention are specified in the dependent claims.

It must be regarded as extremely surprising that the advantages mentioned above are improved not just individually but also cumulatively on their own in that a dielectric body is provided for a mobile radio antenna which is known per se, which dielectric body has at least one extent direction parallel to the reflector plane that is larger than its extent component which runs at right angles to the reflector plane. The dielectric body according to the invention is preferably in the form of a plate. In particular, in a plan view, it may be in the form of an n-sided polygon, and may extend, for example, above a dipole radiating element arrangement, for example a cruciform dipole, a dipole square or a patch radiating element, with the extent position being located above the corresponding radiating elements for a higher frequency band and below the radiating elements at least for the lowest frequency band.

Furthermore, the dielectric body according to the invention, which is also referred to as a dielectric tuning plate in places in the following text, is symmetrical when seen in a plan view, and, above all, may have at least sections which are designed to be and are arranged symmetrically with respect to an individual radiating element arrangement.

Furthermore, it has also been found to be advantageous, in addition or alternatively, to arrange corresponding dielectric bodies at a distance in front of the reflector plate, between two radiating element arrangements which are generally arranged located one above the other in the vertical direction in front of a vertical reflector plane.

The dielectric bodies according to the invention may, for example, be composed of suitable plastic material, for example polystyrene, glass fiber reinforced plastic (GFRP) etc.

A material whose dielectric does not have a high loss factor is preferably used for the dielectric body.

The invention has a particularly advantageous effect, for example, in the frequency bands from 800 to 1000 MHz and from 1700 to 2200 MHz.

The dielectric body is preferably in the form of a plate and extends in a parallel plane in front of the reflector. However, it may also be provided with attachment devices or stand feet (in general spacers etc.) which are composed of the same material, in order to arrange it at a predetermined distance, which has been found to be advantageous, in front of the reflector plate. The extent height is preferably less than λ/2.

The antenna according to the invention makes it possible to achieve a considerable reduction in the frequency dependency of the 3 dB beam width. Mobile radio antennas are frequently set such that they have a 3 dB beam width of 65°. This 65° 3 dB beam width can, however, normally not be set completely identically for the at least two frequency bands, particularly if these are very broad bands. A discrepancy with regard to the at least two intended frequency bands of, for example, 65°±10° (or at least ±7°) is normal in the prior art. According to the invention, this discrepancy can now be improved to 65°±5° (or even only ±4° or less).

As is known, the antennas are frequently adjusted such that they each emit in a horizontal 120° sector angle. This is also referred to as a sector. Three sectors are thus formed per antenna mast. A corresponding mobile radio antenna thus transmits at an angle of +60° or −60°0 at the sector boundaries, with the suppression of the cross-polar components, especially at the sector boundaries according to the prior art, having poor values, particularly in the case of broadband antennas. The antenna according to the invention using the dielectric tuning body in this case allows a ratio of 10 dB or even better to be achieved, even at the sector boundaries at ±60°, with regard to the suppression of the cross-polar component.

If—although this is not absolutely essential according to the invention—cross-polarizing radiating elements are used in a multiband antenna arrangement (that is to say at least in a dual band antenna arrangement), then the decoupling can likewise be improved considerably in this case. The required decoupling is in the order of magnitude of more than 30 dB. This is a very major problem, particularly in the case of broadband antennas or antennas with an electrically adjustable notch. The antenna according to the invention considerably exceeds this value, in particular and even when the antennas have a broad bandwidth and are also electrically adjustable.

Finally, a further positive factor is bandwidth broadening, especially for the higher frequencies.

In summary, it can thus be stated that the advantages mentioned above with the dielectric body according to the invention have a positive effect especially for the higher frequency band or the intended number of frequency bands, with the measures according to the invention having virtually no influence on the lower intended frequency bands, or in each case on the lowest intended frequency bands.

The invention will be explained in more detail in the following text with reference to two exemplary embodiments. In this case, in detail:

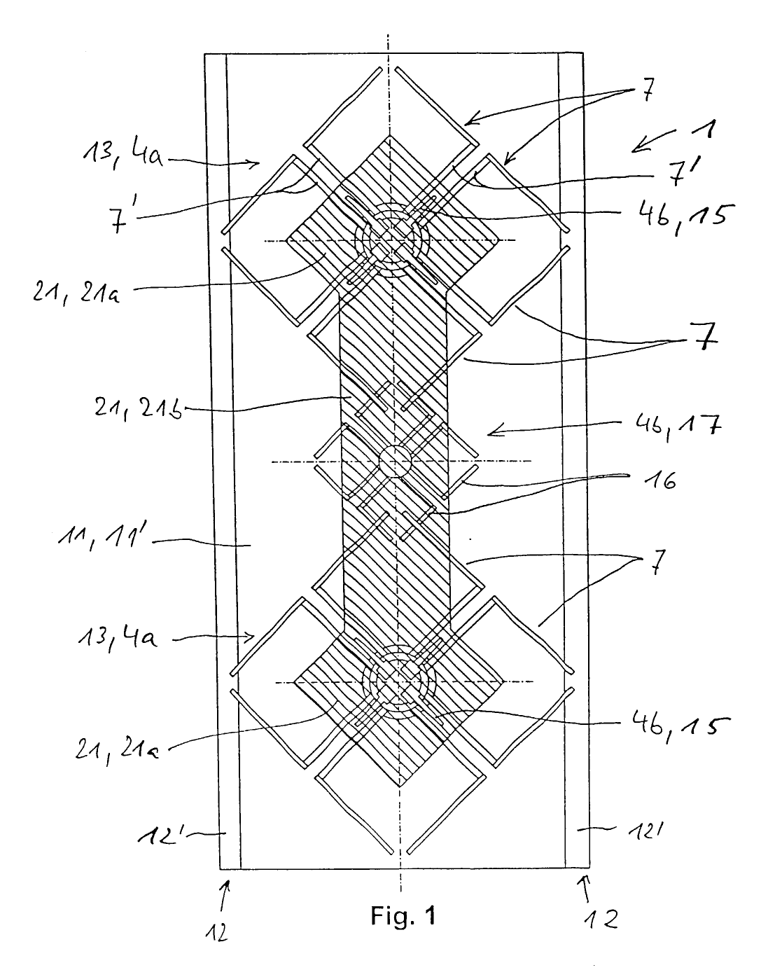

FIG. 1 shows a schematic plan view of a first exemplary embodiment of an antenna according to the invention for the mobile radio field, with a number of radiating elements and a dielectric body provided according to the invention;

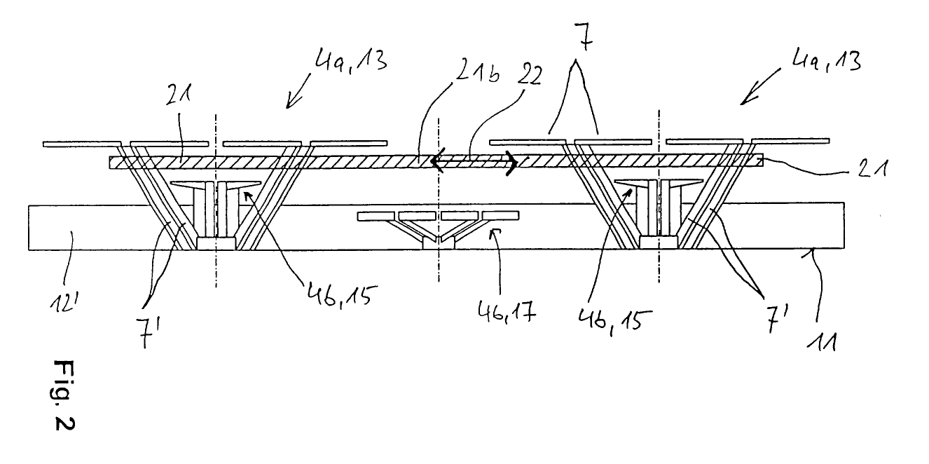

FIG. 2 shows a schematic transverse face view at right angles to the vertical longitudinal extent of the antenna shown in FIG. 1;

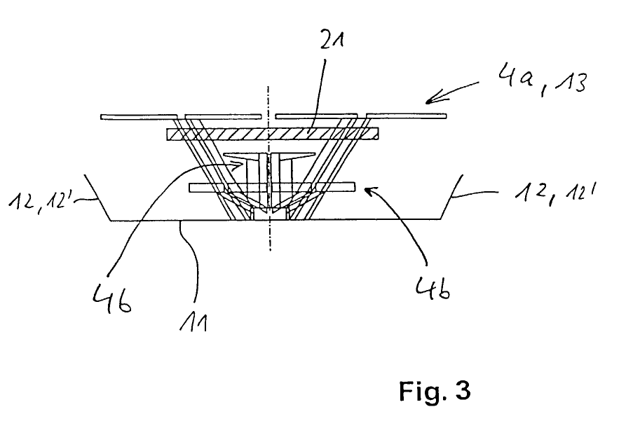

FIG. 3 shows a vertical end face view of the antenna shown in FIGS. 1 and 2;

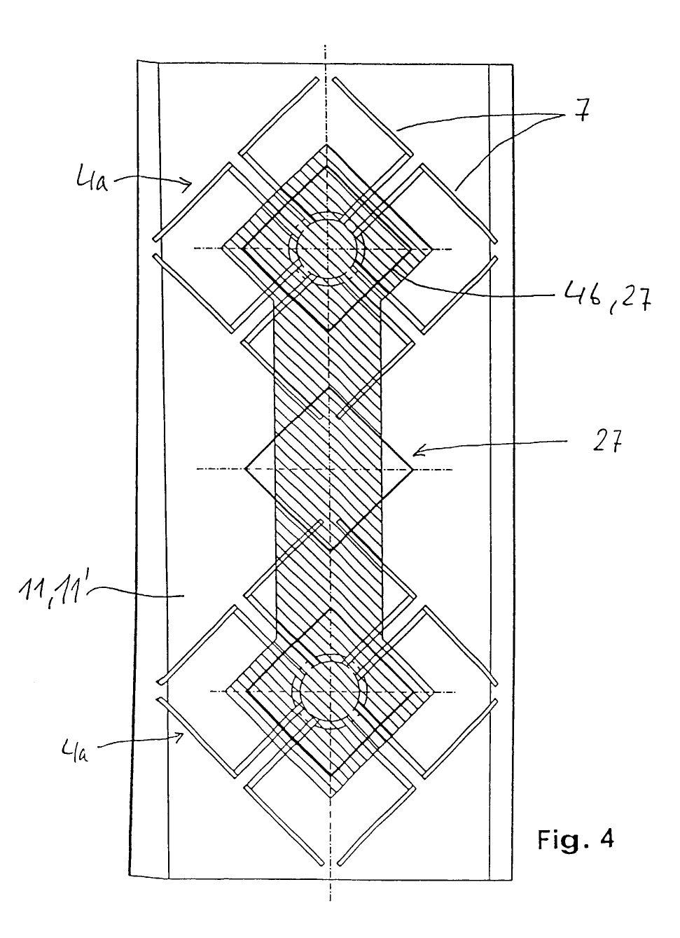

FIG. 4 shows a plan view of an exemplary embodiment modified from that in FIG. 1;

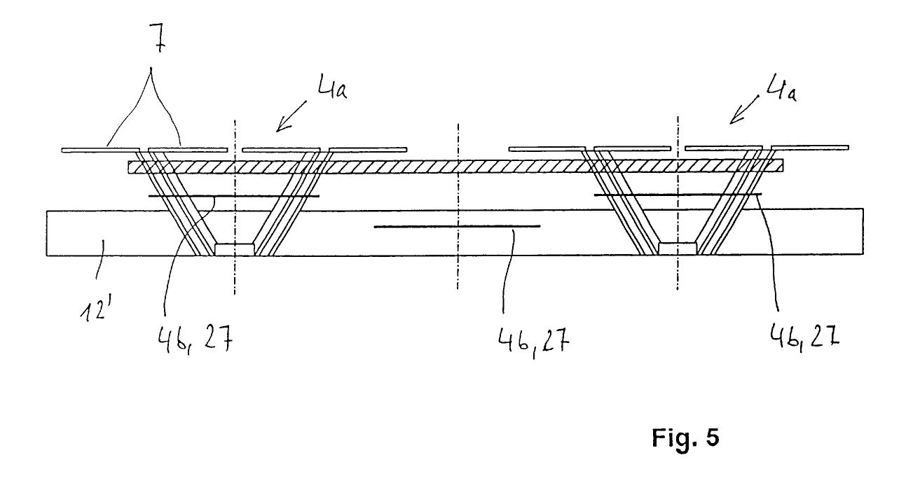

FIG. 5 shows a corresponding transverse face view of the antenna shown in FIG. 4;

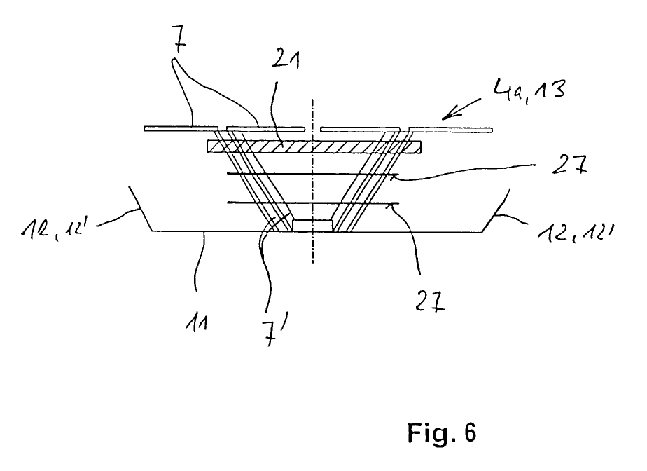

FIG. 6 shows an end face view (of the antenna shown in FIGS. 4 and 5);

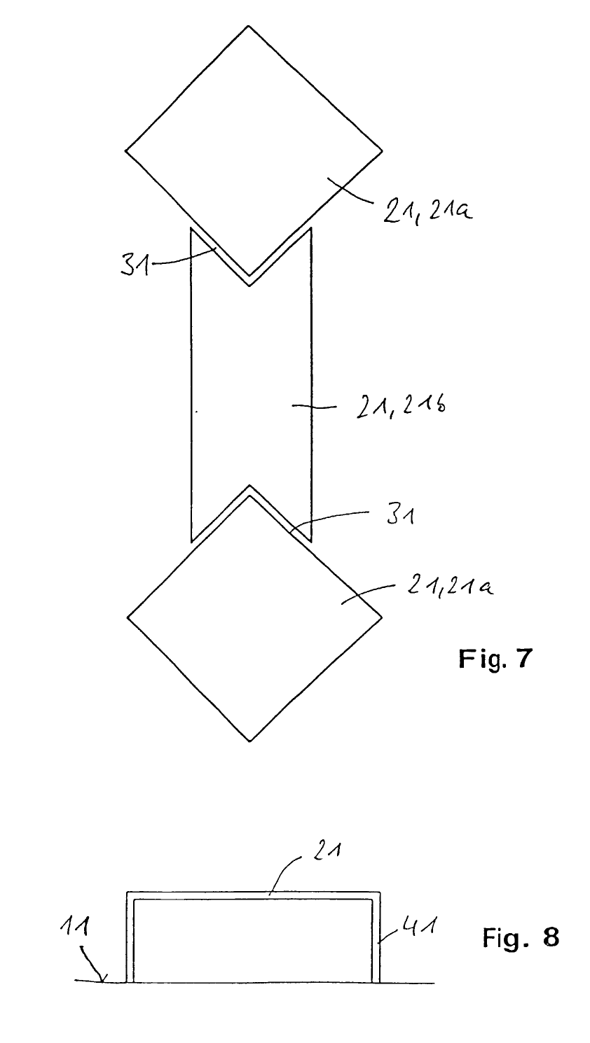

FIG. 7 shows a schematic plan view of a dielectric body which is composed of a number of parts; and

FIG. 8 shows a schematic cross-sectional illustration of a dielectric body provided with spacers or feet.

In a first exemplary embodiment as shown in FIGS. 1 to 3, the antenna 1 has five individual radiating elements, namely two first radiating elements 4a, which are located offset with respect to one another in the vertical direction, for a first, lower frequency band, and three second radiating elements 4b, which are offset in the vertical direction, for a higher frequency band.

The first radiating elements 4a are dipole radiating elements 7, which are arranged in the form of a dipole square 13, are held via so-called balancing devices 7′, at least some of which run to a common center point, and are attached to an electrically conductive reflector 11.

The second radiating elements 4b, which are arranged within these first radiating elements 4a, are formed in the illustrated exemplary embodiment on the basis of a cruciform dipole 15 with two mutually perpendicular dipoles.

The central radiating element device 4b, which is provided between the first radiating elements 4a and likewise belongs to the group of second radiating elements 4b, once again in this exemplary embodiment likewise comprises a dipole square 17 which is formed from four dipoles 16 and which, in principle, is comparable to and similar to the large dipole squares of the first radiating elements 4a.

The radiating elements which have been mentioned are arranged in front of the vertically aligned reflector 11, in which case the reflector 11 may be formed, for example, from a reflector plate 11′, to be precise with two edge sections 12′, which are placed on its vertical sides 12, from the reflector plane, in the emission direction.

As can be seen from the illustrations in FIGS. 1 to 3, a dielectric body 21 is, furthermore, provided in order to improve various antenna characteristics, which dielectric body 21 in the illustrated exemplary embodiment is in the form of a plate and extends at least essentially parallel to the reflector plane. It is preferably located at a distance in front of the reflector plane which is less than λ/2 of the highest transmitted frequency band, or is less than λ/2 of the associated mid-frequency of the highest frequency band. The thickness of the dielectric body may be chosen to be different, within wide limits. Good values are between 2% and 30%, in particular between 5% and 10% of the distance between the individual first radiating elements 4a and the associated reflector 11.

As can be seen in particular from the plan view shown in FIG. 1 in comparison to the two side views shown in FIGS. 2 and 3, the dielectric body 21 has at least one extent component 22 which runs parallel to the plane of the reflector 11 and is larger than its thickness and/or is larger than the distance between its center plane and the plane of the reflector 11, and/or is larger than the distance between the radiating elements 4b, 15 of the radiating elements which are provided for the upper frequency band and the associated plane of the reflector 11.

Finally, it has likewise been found to be advantageous for the dielectric body to be arranged entirely or at least with a part of it at a distance in front of the reflector 11, to be precise above the radiating element arrangement which is intended for the upper frequency band. It has likewise been found to be advantageous for the dielectric body to be arranged entirely or at least with a part of it underneath the radiating element arrangement which is intended for the lower frequency band. Both the conditions mentioned above should preferably be satisfied at the same time, with the effect being particularly advantageous if the dielectric body 21 is thus entirely, or with at least one section, located above the radiating element arrangement which is provided for the upper frequency band, while at the same time being located underneath the radiating element arrangement which is provided for the lower frequency band, and in the process extending entirely or essentially parallel to the reflector. If the dielectric body is not located entirely above the radiating elements which are provided for the upper frequency band and is not located entirely underneath the radiating elements which are intended for the lower frequency band, then the effect is particularly advantageous if, with respect to its overall volume and/or its overall weight, the dielectric body 21 is located at least to an adequate extent in this position, that is to say for example with more than at least 30%, 40%, 50%, or, in particular, with more than 60%, 70%, 80% or 90% of its entire weight and/or volume located in the stated region.

In this case, the illustrated exemplary embodiments also show that, in the projection at right angles to the reflector 11 located underneath it, the at least one dielectric body 21 is smaller than the reflector plate. In fact, the dielectric body may also be of a size which, in the end, corresponds to a size that is larger than the reflector 11.

In the illustrated exemplary embodiment, a first section of the dielectric body 21 is arranged symmetrically within the first radiating elements 4a and thus above the second radiating elements 4b which are located in it, to be precise in a square shape in the illustrated exemplary embodiment—since the first radiating elements 4a are formed from a dipole square.

The dielectric body 21 that is formed in this way, that is to say the dielectric tuning plate 21, is provided in the illustrated exemplary embodiment with a central vertical section 21b, which connects the sections 21a in the region of the dipole squares 13 of the two first radiating element arrangements 4a, which are offset with respect to one another in the illustrated exemplary embodiment. Thus, in the illustrated exemplary embodiment, the dielectric tuning plate 21 which is formed in this way is integral. However, it could also be composed of a number of parts, which correspond at least approximately to the shape shown in FIG. 1, that is to say having two sections 21a which form a square and which, corresponding to the dipole square 13, are each arranged concentrically in respect thereto, parallel to the reflector plane. The longer connecting section 21b could then be provided such that it runs between these two sections 21a.

Particularly for the higher frequencies, for example from 1700 to 2200 MHz (for example 2170 MHz), this allows the 3 dB beam width, the value for the suppression of the cross-polar component, the decoupling and also the increase in bandwidth to be improved in an advantageous manner. Virtually no disadvantageous influences can be found for the lower frequency band or the low frequency bands.

As can be deduced only indirectly from the drawings, the dielectric body is preferably mechanically attached to the radiating elements, for example at their balancing devices.

The exemplary embodiment shown in FIGS. 4 to 6 differs from that shown in FIGS. 1 to 3 in that patch radiating elements 27 are used for the second radiating elements 4b (instead of the cruciform radiating elements 15), that is to say flat radiating elements, for example in the form of a square radiating element, which are aligned at a suitable distance in front of the reflector 11, centrally and symmetrically, with the same polarization alignment with respect to the first radiating elements 4a. A further patch radiating element 27 is also provided, located in the center, between the two patch radiating elements 27, which are each provided in the first radiating element 4a, and this further patch radiating element 27 may be located at a different height, as can be seen in particular from the longitudinal face illustration shown in FIG. 5, and from the end face view shown in FIG. 6. However, the rest of the first dipole radiating elements 4a, which are in the form of a dipole square, could likewise be replaced by patch radiating elements, so that the antenna is in the form of a patch antenna, overall.

With this antenna as well, a corresponding dielectric body 21 is provided as the dielectric tuning element or as the dielectric tuning plate 21, as can be seen from the illustrations.

The dielectric body 21 can be anchored and held in a suitable way for example on the balancing devices 7′ on the individual radiating elements. It can also be provided with stand feet which are likewise, for example, formed from dielectric or from metal, that is to say they may also be conductive.

The dielectric body 21 need not be integral. It may also be formed from a number of isolated separate subsections, which are then effectively joined together to form a desired shape, in which case it is irrelevant if the individual elements from which the dielectric body 21 can be formed do not lie completely flat together in the fitting direction but, for example in a schematic plan view shown in FIG. 7, are located such that spacing gaps 31 remain between the individual elements.

FIG. 8 will now be used to show, only schematically with respect to a cross section through the element 21, how the dielectric tuning element or the dielectric body can also be provided with spacers for attachment to the reflector 21, in which case the spacing elements 41 may be separate spacers or may be composed of the same material as the dielectric body 21 itself. Where and in what size the spacers are formed can be varied as required within wide limits.

The shape may also differ within wide limits. The shape may in this case be changed such that the desired advantageous antenna characteristics can be produced and implemented.

1. An antenna, in particular a mobile radio antenna, for operation in at least two frequency bands, having the following features:
the antenna is provided with a protective shroud composed of nonconductive material,
the radiating elements of the antenna are arranged underneath the protective shroud and in front of the reflector (11),
the radiating elements (4a, 13) for a lower frequency band are arranged at a first distance, or in a first distance range, in front of the reflector (11),
the radiating elements (4b, 15) for the higher frequency band are, in contrast, arranged at a second distance, or in a second distance range, in front of the reflector (11), but closer to it,
characterized by the following further features:
at least one dielectric body (21) which does not form the protective shroud is provided,
more than 40% of the volume, and/or more than 40% of the weight, of the at least one dielectric body (21) is arranged in the region between the reflector (11) and the first distance or the first distance range of the radiating elements (4a, 13) for the lower frequency band, and
more than 40% of the volume and/or more than 40% of the weight of the at least one dielectric body (21) is arranged, as seen from the reflector (11), at more than the second distance or the second distance range for the radiating elements (4b, 15) which are provided for the upper frequency band.

2. The antenna as claimed in the precharacterizing clause of claim 1 or claim 1, having the following features:
the antenna is provided with a protective shroud composed of nonconductive material,
the radiating elements of the antenna are arranged underneath the protective shroud and in front of the reflector (11),
the radiating elements (4a, 13) for a lower frequency band are arranged at a first distance, or in a first distance range, in front of the reflector (11),
the radiating elements (4b, 15) for the higher frequency band are, in contrast, arranged at a second distance, or in a second distance range, in front of the reflector (11), but closer to it,
characterized by the following further features:
at least one dielectric body (21) which does not form the protective shroud is provided, and
at least part of the dielectric body (21) is arranged in the distance area which extends parallel to the reflector (11) and is provided by the radiating elements (4a, 13) for the lower frequency band and by the radiating elements (4b, 15) for the upper frequency band, and
the dielectric body (21) also has an extent component (22) which runs toward the plane of the reflector (11) and is longer than its extent direction which runs at right angles to the plane of the reflector (11), and/or than its distance from the plane of the reflector (11).

3. The antenna as claimed in the precharacterizing clause of claim 1 or claim 1 or 2, having the following features:
the antenna is provided with a protective shroud composed of nonconductive material,
the radiating elements of the antenna are arranged underneath the protective shroud and in front of the reflector (11),
the radiating elements (4a, 13) for a lower frequency band are arranged at a first distance, or in a first distance range, in front of the reflector (11),
the radiating elements (4b, 15) for the higher frequency band are, in contrast, arranged at a second distance, or in a second distance range, in front of the reflector (11), but closer to it,
characterized by the following further features:
a) at least one dielectric body (21) which does not form the protective shroud is provided, and
b) in a vertical plan view of the reflector (11), the dielectric body (21) is arranged such
that the dielectric body (21) is located at the same level as a dipole square (13, 17) or as a radiating element arrangement which is similar to a dipole square and, in this case, is arranged within the dipole square (13, 17) or within the radiating element arrangement which is similar to a dipole square, and/or
that the dielectric body (21) is arranged above a dipole radiating element and/or above a cruciform radiating element (15) or patch radiating element (17), and is thus arranged further away from the reflector (11) than these radiating elements,
c) the entire surface area of the dielectric body (21) or at least the size of the surface area of the dielectric body (21) which is produced by a right-angle projection onto the plane of the reflector (11), is larger than the square of the linear distance which is obtained from the distance between the plane of the reflector (11)
and
the dielectric body (21), or
from the distance between the plane of the reflector (11) and a center plane which runs through the dielectric body (21) or
from the distance between the plane of the reflector (11) and the outer boundary surface, facing away from the reflector plane (11) of the dielectric body (21).

4. The antenna as claimed in the precharacterizing clause of claim 1 or at least one of claims 1 to 3, having the following features:
the antenna is provided with a protective shroud composed of nonconductive material,
the radiating elements of the antenna are arranged underneath the protective shroud and in front of the reflector (11),
the radiating elements (4a, 13) for a lower frequency band are arranged at a first distance, or in a first distance range, in front of the reflector (11),
the radiating elements (4b, 15) for the higher frequency band are, in contrast, arranged at a second distance, or in a second distance range, in front of the reflector (11), but closer to it,
characterized by the following further features:
at least one dielectric body (21) which does not form the protective shroud is provided, and
at least part of the dielectric body (21) extends above parts of the radiating element arrangements (4a, 13; 4b, 15) at a distance in front of the reflector (11),
the dielectric body (21) extends parallel to the reflector (11), and
when viewed in a vertical plan view of the reflector, the dielectric body (21) has a flat extent which is greater than the flat extent, which results parallel to the plane of the reflector (11), of possible spacers, feet or other attachment elements which are part of the dielectric body (21) or are connected to it and run toward the reflector (11).

5. The antenna as claimed in at least one of claims 1 to 4, characterized in that, when viewed in a projection at right angles to the reflector (11), the at least one dielectric body (21) is smaller than the reflector (11) which is located underneath it.

6. The antenna as claimed in at least one of claims 1 to 4, characterized in that, when viewed in a projection at right angles to the reflector (11), the at least one dielectric body (21) is is of precisely the same size as the reflector (11) which is located underneath it.

7. The antenna as claimed in one of claims 1 to 6, characterized in that the dielectric body (21) is mechanically attached to the radiating elements (4a, 13; 4b, 15).

8. The antenna as claimed in one of claims 1 to 7, characterized in that, in a plan view, the at least one dielectric body (21) is in the form of an n-sided polygon.

9. The antenna as claimed in one of claims 1 to 8, characterized in that the at least one dielectric body (21) is at least essentially in the form of a plate.

10. The antenna as claimed in one of claims 1 to 9, characterized in that the dielectric body (21), or at least parts of it, is or are symmetrical with respect to a predetermined radiating element (4a, 4b).

11. The antenna as claimed in one of claims 1 to 10, characterized in that the dielectric body (21) is arranged such that more than 50% of it is at a distance of less than λ/2 from the plane of the reflector (11) with respect to the higher frequency band or the mid-frequency band.

12. The antenna as claimed in one of claims 1 to 11, characterized in that at least the major parts of the dielectric body (21) extend in a region which is located above the radiating element arrangement for the highest frequency band.

13. The antenna as claimed in at least one of claims 1 to 12, characterized in that the dielectric body (21) is composed of plastic, of polystyrene, of ABS or of glass fiber reinforced plastic.

14. The antenna as claimed in one of claims 1 to 13, characterized in that the material for the dielectric body (21) is chosen such that it has a low dielectric loss factor, preferably in the order of magnitude of 10⁻³ or less, and in particular less than 10⁻⁴ and especially 10⁻⁵.

15. The antenna as claimed in one of claims 1 to 10, characterized in that the dielectric body (21) is used in particular for mobile radio antennas for the 900 MHz, the 1800 MHz and/or the 2000 MHz band.

16. The antenna as claimed in one of claims 1 to 15, characterized by the following further features:
more than 50% of the volume, and/or more than 50% of the weight, of the at least one dielectric body (21) is arranged in the region between the reflector (11) and the first distance or the first distance range of the radiating elements (4a, 13) for the lower frequency band, and
more than 50% of the volume and/or more than 50% of the weight of the at least one dielectric body (21) is arranged, as seen from the reflector (11), at more than the second distance or the second distance range for the radiating elements (4b, 15) which are provided for the upper frequency band.

17. The antenna as claimed in one of claims 1 to 16, characterized by the following further features:
more than 70% of the volume, and/or more than 70% of the weight, of the at least one dielectric body (21) is arranged in the region between the reflector (11) and the first distance or the first distance range of the radiating elements (4a, 13) for the lower frequency band, and
more than 70% of the volume and/or more than 70% of the weight of the at least one dielectric body (21) is arranged, as seen from the reflector (11), at more than the second distance or the second distance range for the radiating elements (4b, 15) which are provided for the upper frequency band.
